(19) United States
(12) Patent Application Publication
(10) Pub. No.: US 2024/0342868 A1
(43) Pub. Date: Oct. 17, 2024

(54) DEEP SOCKET

(71) Applicant: EVER DYNASTY INTERNATIONAL CO., LTD., Taichung (TW)

(72) Inventor: Kevin Huang, Taichung (TW)

(21) Appl. No.: 18/299,563

(22) Filed: Apr. 12, 2023

(51) Int. Cl. B25B 13/48

(52) U.S. Cl. CPC B25B 13/481

(57) ABSTRACT

A deep socket includes a connecting portion, a socket portion, and a body portion. The connecting portion is adapted to be connected to a driver. The socket portion has a polygonal hole to engage a nut. The body portion has opposite ends connected to the connecting portion and the socket portion. The body portion has a passageway therein and a slot on a surface thereof. The passageway communicates the polygonal hole of the socket portion, and the slot communicates the passageway. An indicating device is movably connected to the body portion and engaged with the slot to be moved along the slot.

### BACKGROUND OF THE INVENTION

### 1. Technical Field

The present invention relates to a socket wrench, and more particularly to a deep socket, which is capable of obtaining a position of a nut when the nut is turned by the deep socket.

### 2. Description of Related Art

Socket wrench is a hand tool for fastening or loosing nuts or bolts in an easy way. A conventional socket wrench includes a driver and plural sockets of various sizes for replacement. An extension bar may be used to connect the socket and the driver. The driver may be a wrench handle or a power tool. The commonest socket is a barrel with a hexagonal hole for hexagonal nuts. Some sockets have a longer length, so called deep socket, for turning a fastener in a deep and narrow space. In practices, the worker never knows a precise position of a fastener in the deep and narrow space when he/she is turning the fastener. He/she only stops the turning task according to his/her experience, but the fastener is not turned to a desired position frequently. The worker has to take the extra task to adjust the fastener, and the adjusting task usually takes a longer time.

### BRIEF SUMMARY OF THE INVENTION

In view of the above, the primary objective of the present invention is to provide a deep socket, which may allow user to obtain a precise position of a fastener when the fastener is being turned.

In order to achieve the objective of the present invention, a deep socket includes a connecting portion, a socket portion, and a body portion. The connecting portion is adapted to be connected to a driver. The socket portion has a polygonal hole to engage a nut. The body portion has opposite ends connected to the connecting portion and the socket portion. The body portion has a passageway therein to be communicated with the polygonal hole of the socket portion and a slot on a surface to be communicated with the passageway. An indicating device is movably connected to the body portion and engaging the slot to be moved along the slot.

A screw rod is inserted into the passageway of the body portion via the polygonal hole of the socket portion to touch the indicating device, and a nut on the screw rod is received in the polygonal hole of the socket portion; the nut is turned by the socket portion to move on the screw rod when the driver turns the connecting portion, and the indicating device is moved by the screw rod at the same time.

In an embodiment, the indicating device includes a ring and a guide; the ring fits the body portion; the guide has an end connected to the ring and an opposite end entering the passageway through the slot.

In an embodiment, the ring has a bore and an inner thread on a sidewall of the bore; the guide has a shaft with a head and a ball end on opposite ends respectively; the shaft passes through the bore of the ring with the ball end touching a sidewall of the passageway when the shaft enters the passageway through the slot; the shaft has an outer thread to engage the inner thread of the ring.

In an embodiment, the head of the guide is hexagonal.

In an embodiment, the polygonal hole of the socket portion is hexagonal.

In an embodiment, the connecting portion has a hexagonal rod.

In an embodiment, the body portion is provided with a scale member beside the slot.

In an embodiment, wherein the scale member includes a metric scale and an imperial scale at opposite sides of the slot respectively.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a perspective view of a preferred embodiment of the present invention;

FIG. 2 is an exploded view of the preferred embodiment of the present invention;

FIGS. 3 and 4 are front views of the preferred embodiment of the present invention, showing the nut being turned to different locations; and

FIG. 5 is a sectional view of the preferred embodiment of the present invention.

### DETAILED DESCRIPTION OF THE INVENTION

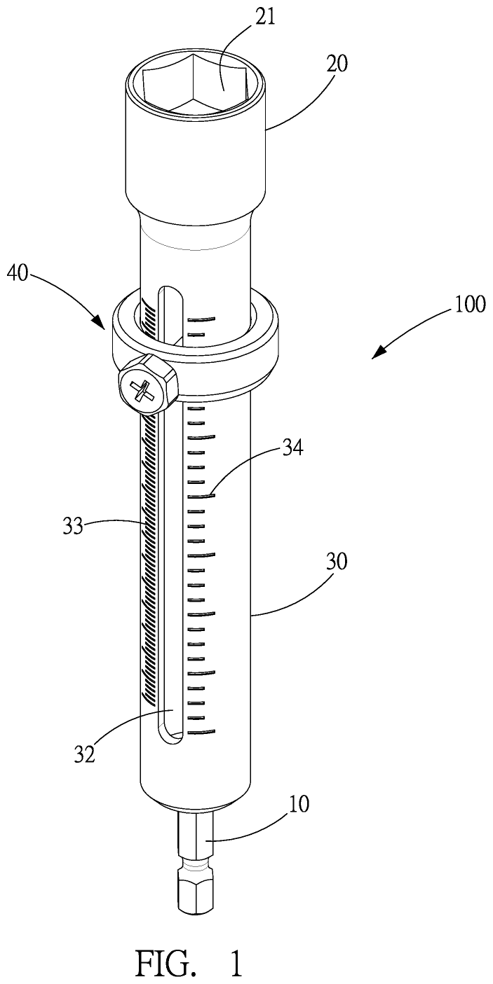

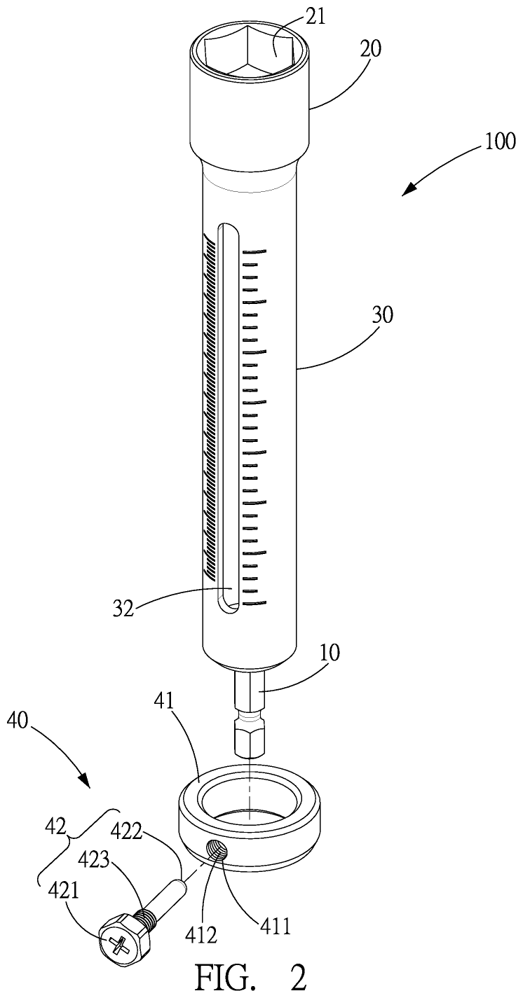

As shown in FIG. 1 and FIG. 2, a deep socket 100 of the preferred embodiment of the present invention includes a main member and an indicating device 40. The main member is a tubular member having a connecting portion 10, a socket portion 20, and a body portion 30.

The connecting portion 10 is a hexagonal rod connected to an end of the body portion 30 to connect to a driver 200. In the present embodiment, the driver 300 is a power tool to connect to the deep socket 100 via the connecting portion 10 for turning deep socket 100.

The socket portion 20 is connected to an end of the body portion 30 opposite to the connecting portion 10. The socket portion 20 has a polygonal hole 21. In the present embodiment, the polygonal hole 21 is a hexagonal (6 points) hole for engagement with a hexagonal nut 300 with a specified size. In another embodiment, the polygonal hole 21 is a 12-sided (12 points) hole.

The body portion 30 has a passageway 31 therein with an end thereof communicated with the polygonal hole 21 of the socket portion 20. The body portion 30 has an elongated slot 32 on a surface thereof, and the slot 32 is communicated with the passageway 31. The body portion 30 further has a scale member on the surface. In the present embodiment, the scale member has a metric scale 33 at a side of the slot 32 and an imperial scale 34 at the other side.

The indicating device 40 is movably connected to the body portion 30 for reciprocation. The indicating device 40 includes a ring 41 and a guide 42. The ring 41 fits to the body portion 30, and the guide 42 has an end connected to the ring 41 and the other end inserted into the slot 32. In the present embodiment, the ring 41 has a bore 411 aligned with the slot 32 and an inner thread 412 on a sidewall of the bore 411. The guide 42 is a bolt-like member having a shaft with a hexagonal head 421 on an end thereof and a ball portion 422 on the other end. The shaft also is provided with an outer thread 423 proximal to the head 421. The guide 42 has the shaft passing through the bore 411 of the ring 41 and then entering the slot 32. Next, the guide 42 is turned until the inner thread 412 engaging the outer thread 423 and the ball portion 422 of the shaft slightly touching a sidewall of the passageway 31 of the body portion 30.

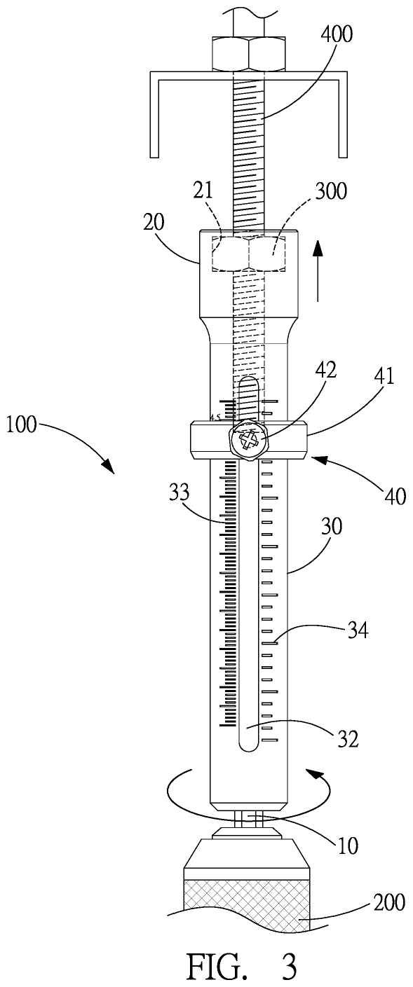

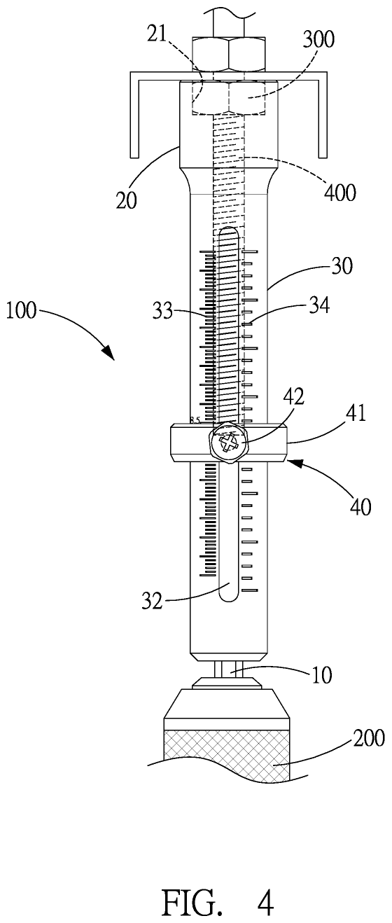

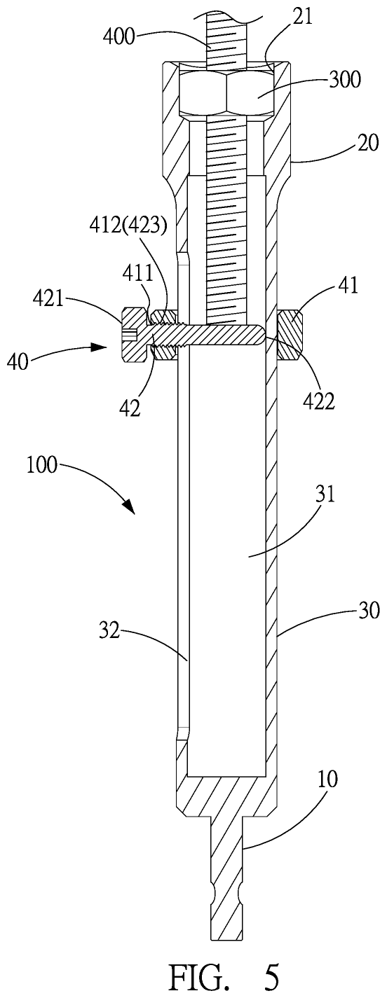

As shown in FIGS. 3 and 4, before a turning task the screw rod 400 (without the nut 300) is inserted into the passageway 31 of the body portion 30 via the polygonal hole 21 of the socket portion 20 until the screw rod 400 is totally received therein. Next, the indicating device 40 is moved until the guide 42 touches the screw rod 400, and then read the number of the scale member 33 or 34 corresponding to the ring 41 (this number indicates a length of the screw rod 42). Remove the deep socket 100 and engage the nut 300 with the screw rod 400, and then engage the deep socket 100 with the screw rod 400 again with the nut 300 received in the polygonal hole 21, and move the indicating device 40 until the guide 42 touches the screw rod 400 (as shown in FIG. 5). A driver 200 is connected to the connecting portion 10 to turn the deep socket 100. The indicating device 40 is moved by the screw rod 400 when the driver 20 is turning the deep socket 100. The turning task is complete when the ring 41 arrives at the number of the scale member 33. For example, the first-time engagement of the deep socket 100 and the screw rod 400 shows that the length of the screw rod 400 is 8.5 cm. the second-time engagement of the deep socket 100 and the screw rod 400 with the nut 300, referring to FIG. 3, shows that the nut 300 locates at 4.5 cm of the screw rod 400. The driver 200 is connected to the connecting portion 10 to turn the deep socket 100 so as to move the nut 300 upwardly (based on the direction shown in FIGS. 3 and 4), and the indicating device 40 will be moved downwardly at the same time. When the ring 41 of the indicating device 40 reaches to 8.5 cm position, referring to FIG. 4, it means that the nut 300 had being turned to the end of the screw rod 400. The turning task is complete now. As a result, the deep socket 100 of the preferred embodiment of the present invention allows user to obtain a precise position of the nut 300 on the screw rod 400 visually. It does not have to stop turning to verify the position of the nut 300 that may shorten the working time.

It must be pointed out that the embodiments described above are only some preferred embodiments of the present invention. All equivalent structures which employ the concepts disclosed in this specification and the appended claims should fall within the scope of the present invention.

What is claimed is:

1. A deep socket, comprising:
a connecting portion adapted to be connected to a driver;
a socket portion having a polygonal hole to engage a nut;
a body portion having opposite ends connected to the connecting portion and the socket portion, wherein the body portion has a passageway therein and a slot on a surface thereof;
the passageway communicates the polygonal hole of the socket portion, and the slot communicates the passageway; and
an indicating device movably connected to the body portion and engaging the slot to be moved along the slot;
wherein a screw rod is inserted into the passageway of the body portion via the polygonal hole of the socket portion to touch the indicating device, and a nut on the screw rod is received in the polygonal hole of the socket portion: the nut is turned by the socket portion to move on the screw rod, and the indicating device is moved by the screw rod at the same time when the driver turns the connecting portion.

2. The deep socket of claim 1, wherein the indicating device includes a ring and a guide:
the ring fits the body portion: the guide has an end connected to the ring and an opposite end entering the passageway through the slot.

3. The deep socket of claim 2, wherein the ring has a bore with an inner thread on a sidewall thereof: the guide has a shaft with a head and a ball end on opposite ends respectively: the shaft passes through the bore of the ring with the ball end touching a sidewall of the passageway when the shaft enters the passageway through the slot: the shaft has an outer thread to engage the inner thread of the ring.

4. The deep socket of claim 3, wherein the head of the guide is hexagonal.

5. The deep socket of claim 1, wherein the polygonal hole of the socket portion is hexagonal.

6. The deep socket of claim 1, wherein the connecting portion has a hexagonal rod.

7. The deep socket of claim 1, wherein the body portion is provided with a scale member beside the slot.

8. The deep socket of claim 7, wherein the scale member includes a metric scale and an imperial scale at opposite sides of the slot respectively.
